(19) United States
(12) Patent Application Publication
(10) Pub. No.: US 2025/0334433 A1
(43) Pub. Date: Oct. 30, 2025

(54) SYSTEM AND METHOD FOR DEPTH-BASED FLOW METERING

(71) Applicant: Hampton Roads Sanitation District, Virginia Beach, VA (US)

(72) Inventors: Steven Poe, Virginia Beach, VA (US); Arba Williamson, Virginia Beach, VA (US)

(21) Appl. No.: 19/185,415

(22) Filed: Apr. 22, 2025

Related U.S. Application Data
(60) Provisional application No. 63/638,183, filed on Apr. 24, 2024.

(51) Int. Cl. G01F 1/002; E03F 7/12; G01F 23/296

(52) U.S. Cl. CPC G01F 1/002; E03F 7/12; G01F 23/296; E03F 2201/20

(57) ABSTRACT

A system and method for measuring or for estimating flow or flowrate of a fluid, including wastewater inflow or infiltration, using non-contact depth-based flow measurement, including: receiving a depth sensor signal from an ultrasonic depth sensor positionable over a manhole channel above an outgoing pipe's crown; receiving a temperature signal from a temperature sensor positionable within the manhole channel; receiving one or more data input signals; calculating a distance to a surface of the fluid based on the received depth sensor signal; and determining a depth of the fluid in the manhole channel based on the calculated distance. Flow velocity may be calculated using Manning's equation or the Hazen-Williams equation, with flow rate subsequently determined using the continuity equation. Alternatively, flow velocity and flow rate may be estimated using a machine learning model trained on simulated or historical time-series data of flow rate, flow velocity, and flow depth, along with pipe attributes, to generate real-time flow estimates based on current and prior flow depth measurements.

### CROSS REFERENCE TO RELATED APPLICATION

This application is entitled to and hereby claims priority under 35 U.S.C. § 119(e) to U.S. Provisional Patent Application No. 63/638,183, filed Apr. 24, 2024, titled “System and Method for Depth-Based Flow Metering,” the disclosure of which is hereby incorporated herein in its entirety by this reference.

### FIELD OF THE DISCLOSURE

The present disclosure relates to an apparatus, a system and a computer-implemented method for detecting, measuring or estimating flow, including wastewater inflow, infiltration, and flowrate in a sewer system.

### BACKGROUND

U.S. Pat. No. 9,297,684 to Gregory M. Quist et al., issued Mar. 29, 2016, which was previously published as U.S. Paten Publication No. US 2015/0066396 on Mar. 5, 2015, describes a device and methodology for estimating flowrates of a liquid conduit, including calculating flowrate based on flow depth measurements in a pipe.

U.S. Pat. No. 10,630,874 to Brandon C. Freeman et al., issued Apr. 21, 2020, describes a system and methodology for wastewater monitoring using a level sensor to monitor wastewater level in a pipe. Once a level threshold is met, a camera is triggered to wake up and capture images, which can be viewed remotely.

U.S. Pat. No. 11,781,897 to Shi-En Shiau et al., issued Oct. 10, 2023, including counterpart Chinese Patent Application No. CN116710736, describes a non-contact sensor system and method for measuring free surface flow and pressure flow in a conduit. The patent teaches an online metering station for measuring both pressure flow and free surface flow in a pipe without requiring contact with the water. The system provides continuous flow measurement using a pair of risers (or pipes) mounted on a buried conduit with sensors to measuring water depth in each riser (similar to Venturi meter).

U.S. Pat. No. 8,857,256 to John Michael Hamden Barton, issued Oct. 14, 2014, which was previously published as U.S. Patent Publication No. US 2014/0000360 on Jan. 2, 2014, describes an apparatus and methodology for monitoring, including micro-monitoring, for monitoring sanitary sewer systems using a weir, supportive band, and level velocity sensor to detect inflow and infiltration (I&I) during at least one precipitation event.

There exists an unfulfilled need for a non-contact depth-based metering solution for detecting wastewater inflow and infiltration, and for estimating flowrate in a sewer system using a non-contact depth-based flow meter.

### SUMMARY OF THE DISCLOSURE

The disclosure provides a novel apparatus, system and processor-implemented methodology for detecting, measuring or estimating flow, including wastewater inflow and infiltration, and flow in a sewer system.

According to an aspect of the disclosure, an apparatus is provided for measuring or for estimating flow or flowrate of a fluid, including wastewater inflow or infiltration, using non-contact depth-based flow measurement. The apparatus comprises; a processor configured to execute one or more computer program instructions; a memory configured to store data; an ultrasonic depth sensor configured to be positioned inside a manhole above a crown of an outgoing pipe, the ultrasonic depth sensor being configured to measure a distance to a surface of a fluid without direct contact with the fluid; and a temperature sensor configured to measure temperature of the fluid within the channel to confirm the presence of inflow or infiltration.

The apparatus can further comprise: a conductivity sensor configured to detect presence of saltwater within the fluid and send a conductivity sensor signal to the processor; and/or a gas sensor configured to measure a concentration level of a gas, including a methane gas in the manhole, the channel, or the wet well, and send a gas sensor signal containing the concentration level to the processor.

The processor can be configured to: receive the gas sensor signal; compare the concentration level to a concentration threshold value; and power down electronics if the concentration level exceeds the concentration threshold value.

The apparatus can further comprise: a receiver configured to receive electronic signals, including sensor signals, data signals, or command signals; and a transmitter configured to send electronic signals, including command signals and data signals.

The apparatus can further comprise an enclosure configured to hold a plurality of components and seal the components from a surrounding environment. The enclosure can comprise a gasket and a fastener. The fastener can comprise one or more screws, bolts, nuts, rivets, or welds.

The enclosure can comprise a hermetically sealed chamber containing the plurality of components. The plurality of components can comprise at least one of: the processor; the memory; a battery; a rechargeable battery; a removable memory; and a memory reader device. The removable memory can comprise a micro-SD card and the memory reader device comprises a micro-SD card reader.

The enclosure can comprise a 3D printed enclosure that is splash-resistant. The enclosure can comprise at least one of: a sealed micro-USB port on an exterior of the enclosure; and a sealed charge port for charging at least one of the plurality of components.

The apparatus can further comprise one or more magnets embedded in, or attached to, the enclosure for attaching the enclosure to a metal structure. The one or more magnets can comprise a neodymium magnet for adherence to the metal structure. The metal structure can comprise a manhole frame.

The apparatus can comprise at least one of: a camera configured to capture one or more images, including a video, of a field of view; a raindrop sensor configured to detect a raindrop; and one or more servo motors configured to: open and close a camera lens cover; and/or move or pan the camera along an x-axis, a y-axis, or a z-axis, or any combination of x-, y-, z-axes so as to change the field of view, including zooming in or out.

The field of view can comprise the manhole channel. The camera can be configured to record a video in the manhole channel. The camera can be configured to record the video in response to a signal received from at least one of: the raindrop sensor; the temperature sensor; the conductivity sensor; or the ultrasonic depth sensor.

The memory can be configured to store the one or more computer program instructions. The one or more computer program instructions can include a Python script or a Micropython script for: communicating, via one or more communication links, with one or more sensors; or communicating, via one or more communication links, with one or more communicating devices; or determining the distance to the surface of the fluid without direct contact with the fluid; or determining the temperature of the fluid in the manhole channel to confirm the presence of inflow or infiltration; or determining the conductivity of the fluid to detect the presence of saltwater; or determining concentration level of gas, including methane gas in the manhole channel; or powering down electronics based on the concentration; or estimating flowrate based on fluid depth; or requesting, via an input-output interface, at least one input comprising a sensor height, a sample rate, an outgoing pipe diameter, an outgoing pipe slope, and an outgoing pipe roughness coefficient; or communicating with at least one of a camera and a raindrop sensor, including sending commands to operate the camera and control one or more servo motors.

A method for measuring or for estimating flow or flowrate of a fluid, including wastewater inflow or infiltration, using non-contact depth-based flow measurement, the method comprising: receiving, by a computing device, a depth sensor signal from an ultrasonic depth sensor, the ultrasonic depth sensor being positionable over a manhole channel above an outgoing pipe's crown, the ultrasonic depth sensor being configured to measure a distance to a fluid's surface without direct contact with the fluid; receiving, by the computing device, a temperature signal from a temperature sensor positionable within the manhole channel, the temperature sensor being configured to measure temperature within the manhole channel or the fluid to confirm the presence of inflow or infiltration; receiving, by the computing device, one or more data input signals; calculating, by the computing device, a distance to a surface of the fluid based on the received depth sensor signal; and determining, by the computing device, a depth of the fluid in the manhole channel based on the calculated distance.

The method can comprise: receiving, by the computing device, a conductivity sensor signal from a conductivity sensor, the conductivity sensor being positionable within the manhole channel and configured to measure conductivity of the fluid; and determining, by the computing device, presence of saltwater within the fluid based on the conductivity sensor signal.

The method can comprise receiving, by the computing device, a concentration level signal from a gas sensor configured to measure a concentration level of a gas, including a methane gas in the manhole channel.

The method can comprise receiving, by the computing device, a gas sensor signal containing a concentration level; comparing, by the computing device, the concentration level to a concentration threshold value; and powering down, by the computing device, electronics if the concentration level exceeds the concentration threshold value.

The method can comprise calculating, by the computing device, a flow velocity of the fluid using a physics-based approach such as Manning's equation based on attributes of an outgoing pipe, including at least one of a diameter, a slope, a roughness, and flow depth. Alternatively (or additionally), a trained machine learning model can be used to estimate flowrate and flow velocity based on a range of inputs, including pipe diameter, slope, roughness, and real-time and/or historical flow depth measurements.

The method can comprise calculating, by the computing device, a flowrate of the fluid, using a Continuity equation, based on the flow velocity and cross-sectional area of flow. The Continuity equation-based calculation can be supplemented by a machine learning model that predicts flowrate based on historical and simulated data patterns, enhancing the prediction accuracy in more complex flow scenarios, like surcharging.

The method can comprise calculating, by the computing device, a flow velocity of the fluid using Hazen Williams equation and attributes of an outgoing pipe, including at least one of a diameter, a slope, and a roughness. Alternatively (or additionally), flow velocity can be predicted using a machine learning model that is trained on simulated or historic flow data, accounting for variations in pipe diameter, slope, roughness, and real-time/prior flow depth measurements.

The method can comprise calculating, by the computing device, a flowrate of the fluid, using a Continuity equation, based on the flow velocity and cross-sectional area of flow. Alternatively (or additionally), flowrate can be predicted using a machine learning model that is trained on simulated or historic flow data, accounting for variations in pipe diameter, slope, roughness, and prior flow depth measurements.

The flow velocity can comprise sewer flow velocity. The flowrate can comprise sewer flowrate.

The one or more data input signals can be received from a human user interface. The human user interface can comprise at least one of: a touch screen display; a keyboard; a mouse; a stylus; or an interactive voice response (IVR) unit. The one or more data input signals can comprise at least one of: a sensor height; a sample rate; a pipe diameter; an outgoing pipe diameter; a pipe slope; an outgoing pipe slope; a Manning's roughness coefficient; a Hazen Williams roughness coefficient; and flow depth measurements from the ultrasonic depth sensor.

The method can comprise: sampling, by the computing device, a distance from the ultrasonic depth sensor to a surface of the fluid; or calculating, by the computing device, a distance from the ultrasonic depth sensor to a surface of the fluid; or estimating, by the computing device, depth of the fluid in the manhole channel; or calculating, by the computing device, a cross-sectional area of flow; or calculating, by the computing device, a wetted perimeter; or calculating, by the computing device, a hydraulic radius; or estimating, by the computing device, a cross-sectional area of flow; or estimating, by the computing device, a wetted perimeter; or estimating, by the computing device, a hydraulic radius; or storing data, by the computing device, including at least one of a date, a time, a distance to a fluid's surface, a fluid depth, a fluid temperature, a fluid conductivity, a cross-sectional flow area, a flow velocity, and a flowrate. The storing of data can comprise storing data in a memory in the computing device and saving it at intervals to a removable memory. The removable memory can comprise a micro-SD card. Additionally, the system can include a mechanism for periodically retraining or tuning the machine learning model based on new data to improve the model's prediction capabilities over time.

The method can be carried out by the computing device executing a plurality of computer program instructions. The computer program instructions can comprise a Python script or a Micropython script stored on the computing device. The one or more computer program instructions can comprise instructions for: communicating, via one or more communication links, with one or more sensors; or communicating, via one or more communication links, with one or more communicating devices; or determining the distance to the surface of the fluid without direct contact with the fluid; or determining the temperature of the fluid within the channel to confirm the presence of inflow or infiltration in the manhole channel; or determining the conductivity to detect presence of saltwater within the fluid; or determining concentration level of gas, including methane gas in the manhole; or powering down electronics based on the concentration; or estimating flowrate based on fluid depth using a physics-based equation and/or a trained machine learning model; or updating machine learning model parameters based on newly collected sensor data to improve flow estimation accuracy over time; or requesting, via an input-output interface, at least one input comprising a sensor height, a sample rate, an outgoing pipe diameter, an outgoing pipe slope, an outgoing pipe roughness coefficient; or communicating with a camera to record a video of a field of view of the camera, including, for example, a manhole channel; or communicating one or more servo motors to move, pan, or tilt the camera, or to open and close a camera lens cover; or communicating with a raindrop sensor to receive a raindrop sensor signal.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 illustrates a non-limiting embodiment of a flow metering system constructed according to the principles of the disclosure.

FIGS. 2A-2C illustrate a non-limiting embodiment of a housing for containing a flow meter apparatus, constructed according to the principles of the disclosure.

FIG. 3 illustrates a non-limiting embodiment of a controller, constructed according to the principles of the disclosure.

FIG. 4 illustrates a non-limiting embodiment of a process for training a machine learning model, according to the principles of the disclosure.

FIG. 5A illustrates a process for calculating flow in an open channel, according to the principles of the disclosure.

FIG. 5B illustrates methodologies for implementing Manning's equation, Hazen-Williams equation, and Continuity equation according to principles of the disclosure.

FIG. 6 illustrates an embodiment of a process of installing the flow metering system of FIG. 1 in an open channel.

FIG. 7 illustrates an embodiment of the open channel installation according to the process of FIG. 6.

FIG. 8 illustrates another embodiment of a process of installing the flow metering system of FIG. 1 in an open channel.

FIG. 9 illustrates an embodiment of the open channel installation according to the process of FIG. 8.

FIG. 10 illustrates another embodiment of a process for calculating flow velocity and flowrate according to the principles of the disclosure.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

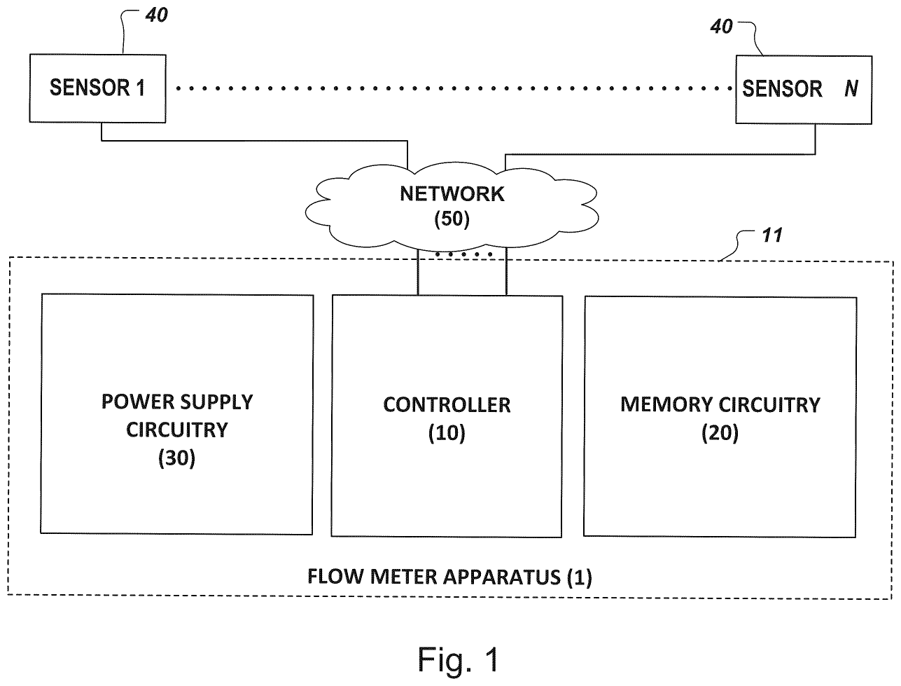

According to an aspect of the disclosure, a system is constructed and provided for detecting, measuring, and monitoring flow for non-contact depth-based flow metering, including for detecting wastewater inflow and infiltration. FIG. 1 depicts a non-limiting embodiment of the system, constructed according to the principles of the disclosure. The system includes a flow meter apparatus 1 and one or more sensors 1 to N (where N is a positive integer greater than 2), each of which can be communicatively coupled via one or more communication links, directly or through a network 50, to the flow meter apparatus 1. In various embodiments, one or more of the sensors 40 can be included in the flow meter apparatus 1, external to the flow meter apparatus 1 (as seen in FIG. 1), or both internal and external to the flow meter apparatus 1, in which case at least one sensor 40 is located in the flow meter apparatus 1 and at least one sensor 40 is located external to the flow meter apparatus 1.

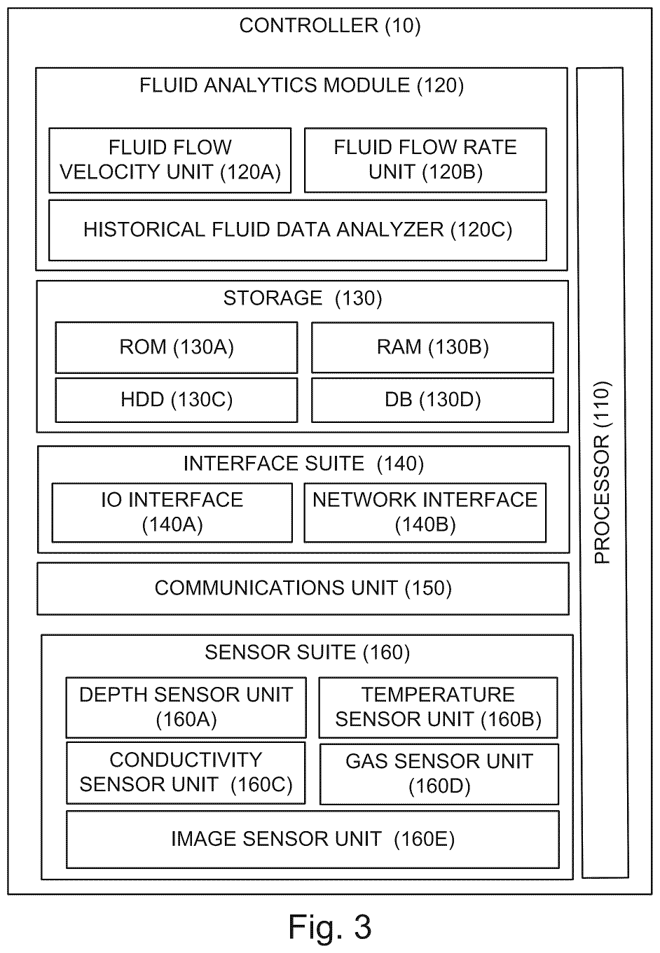

The flow meter apparatus 1 can include a controller 10, memory circuitry 20, and power supply circuitry 30. The controller 10 can be arranged, for example, as seen in FIG. 3. Each of the components 10, 20, 30 of the flow meter apparatus 1 can be housed in a housing 11 made of an environmentally suitable material and interconnected via communication links. In an embodiment the housing 11 can be hermetically sealed.

In various embodiments the memory circuitry 20 includes a memory such as, for example, a microSD card, a USB flash drive, a solid-state drive, a portable hard drive, or other high performance storage device. The memory can be fixed or removable. The memory circuitry 20 can further include an interface (not shown) that can be connected to the controller 10 by a communication link. The interface can include, for example, a microSD card reader or other device that facilitates exchange of data and instructions between the controller 10 and memory.

The power supply circuitry 30 can include a power supply (for example, a battery or external power source), a voltage regulator, and a circuit interrupter (for example, a fuse, switch, circuit breaker). The power supply circuitry 30 can be configured to provide power to the entire system, including controller 10, memory circuit 20, and one or more of the sensors 40.

The sensors 40 can include sensor devices that are arranged to detect and measure conditions such as, for example, temperature, pressure, humidity, precipitation (for example, rain), light intensity, radiation, concentration, pH, density, viscosity, conductivity, capacitance, flow, velocity, and direction of a fluid. In certain embodiments, the sensor 40 can include chemical identification analyzers, such as, for example, FTIRs, Raman Spectroscopy devices, mass spectrometers, high-pressure mass spectrometers (HPMS), CCD camera-based spectrometers, or Raspberry Pi camera-based spectrometers.

In various embodiments the sensors 40 (sensor 1 to sensor N) can include any one or more of a temperature sensor device, a thermal conductivity sensor device, a pressure sensor device, a humidity sensor device, a rain sensor, a light sensor device, a radiation sensor device, a gas sensor device, a pH sensor device, a density sensor device, a viscosity sensor device, a depth sensor device (for example, ultrasonic depth sensor), a fluid sensor device, a chemical analyzer device, an optical sensor device (for example, a line CCD (charge-coupled-device) sensor, CCD array, or a camera device). The fluid sensor can be arranged to measure properties of a fluid, including ambient conditions surrounding the fluid. For instance, the fluid sensor can include one or more devices arranged to measure any forces (for example, pressure) exerted by or on the fluid, movement of the fluid (including, for example, velocity and direction of movement of the fluid), temperature of the fluid, fill level of the fluid. The fluid can include a liquid, a gas, a liquid-gas mixture, a liquid-solid mixture, a gas-solid mixture, or a liquid-gas-solid mixture that is stationary or moving. In various applications the fluid can include water, wastewater, and/or surrounding gases.

In various embodiments, the controller 10 is arranged for interacting with one or more of the sensors 40, executing scripts, and processing and storing data. In certain applications one or more depth sensors 40 can be positioned inside a manhole (such as, for example, above a crown of an outgoing pipe) and one or more temperature sensors, conductivity sensors, and/or gas sensors arranged to measure and monitor the fluid and surrounding environment. The temperature sensor can be arranged to measure the fluid's temperature within a channel and, via interaction with the controller 10, can verify the presence of inflow and infiltration by detecting distinct temperature signatures of the fluid, as the fluid exhibits differing thermal characteristics from inflow and infiltration. The conductivity sensor can be arranged to detect the presence of saltwater within the fluid stream or, for example, a wet well. The gas sensor can include one more devices arranged to measure a molar mass, concentration, density, volume, temperature, and/or pressure of one or more gases or gas mixtures, such as, for example, oxygen, nitrogen, hydrogen, carbon-monoxide, carbon-dioxide, methane, or other gas(es), such as, for example, within the manhole or wet well, wherein the gas concentration (for example, methane concentration) can be monitored as a safety measure, and if the concentration of the gas(es) reaches a threshold (for example, a lower explosive or toxicity limit) any components within the area can be controlled to minimize risk to animals, including, for exampling, powering down electrical components to prevent explosion resulting from, for example, an electrical spark.

In at least one embodiment the housing 11 includes a hermetically sealed three-dimensional enclosure. The enclosure can be arranged to open to provide access to components of the system, including the flow meter apparatus 1 (shown in FIG. 1), and close such that a hermetic seal is formed that prevents any fluids from entering into (or exiting from) the inner chamber(s) formed by the enclosure.

In an embodiment the housing 11 includes a three-dimensional (3D) printed enclosure containing a gasket and a plurality of screws housing the controller 10, memory circuitry 20, and power supply circuitry 30.

The housing 11 can include one or more neodymium magnets embedded in or attached to a wall of the housing 11 for adherence to a structure such as, for example, a manhole frame.

The housing 11 can be splash-resistant and comprise a sealed micro-USB port on the exterior of the enclosure for data retrieval and a sealed charge port for recharging a battery in the power supply circuitry 30. The controller 10 can be arranged to process, for example, Micropython or Python script for estimating the flowrate for a given fluid depth.

The housing 11 can include a human-machine interface (HMI) accessible from outside the enclosure so as to facilitate data input and output without any need to open the housing 11. The HMI can include a display device, a touch-screen display device, a keyboard, a microphone, a speaker, or other tactile, audio, or optical/visual interface device arranged to exchange data and instructions between, for example, the flow meter apparatus 1 and/or sensors 40 and a user or operator (including, human or machine). The HMI can be arranged, for example, to display data in a visual format to a user; receive commands from the user to adjust settings and control processes in real-time; record and store data for analysis, troubleshooting, and optimization; and/or generate alarms to alert the user to issues or abnormalities in the system, allowing for quick response and resolution. In an embodiment, the HMI is arranged to receive user inputs such as, for example, sensor height, sample rate, outgoing pipe diameter, outgoing pipe slope, and outgoing pipe roughness coefficient, and communicate the inputs to the controller 10.

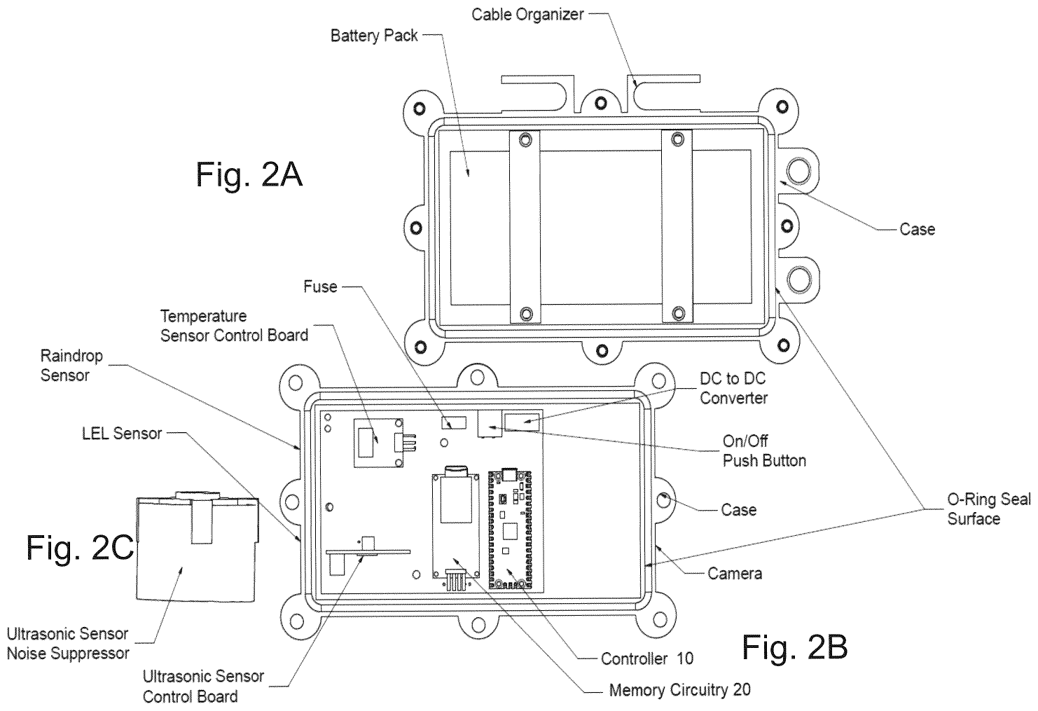

FIGS. 2A and 2B depict respective first and second halves of an embodiment of a housing case for the housing 11, and FIG. 2C depicts an embodiment of an ultrasonic sensor with noise suppressor. The first half of the case can include the power supply circuitry 30, including, for example, a battery pack to supply electrical power, and a cable organizer to organize cables located proximate to the housing 11. The second half of the case can include, for example, the controller 10, memory circuitry 20, a raindrop sensor, a temperature sensor control board, a fuse, a DC-to-DC converter, an ON/OFF push button, and optical sensor (for example, camera), and an ultrasonic sensor control board. The first and second halves of the case can be coupled to each other and sealed by an O-ring seal provided therebetween. Each of the first and second halves of the case can include an O-ring seal surface.

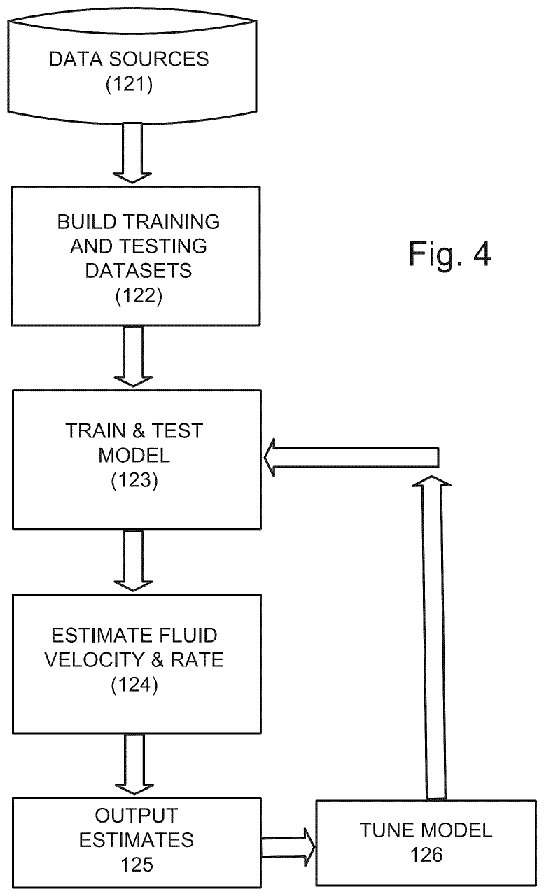

FIG. 3 depicts a non-limiting embodiment of the controller 10. The controller 100 can be arranged to interact with each of the components in the system (for example, shown in FIG. 1), including the memory circuitry 20, the power supply circuitry 30, the sensors 40, the network 50, and/or one or more communicating devices (not shown) that are external to the system. The controller 10 can be configured to perform and/or interact with each of the processes/methods disclosed herein, as will be understood by those skilled in the art, including, for example, the processes (or steps thereof) depicted in FIGS. 4, 5 and 7.

The controller 10 can be included, for example, in the housing 11 (shown in FIG. 1). The controller 10 can be configured to communicate with the one or more communicating devices (not shown) either directly or via the network 50. The controller 10 can include a processor 110, a fluid analytics module 120, a storage 130, an interface suite 140, a communications unit 150, and a sensor driver suite 160. The controller 10 can include a bus (not shown), which can connect to each of, and facilitate communication and interaction between, any of the computer resource assets (or components) in the controller 10. The bus (not shown) can include any of several types of bus structures that may further interconnect to a memory bus (with or without a memory controller), a peripheral bus, and a local bus using any of a variety of commercially available bus architectures.

The processor 110 can include any of various commercially available processors, multi-core processors, microprocessors or multi-processor architectures.

The fluid analytics module 120 includes a plurality of computer resource assets 120A, 120B, 120C, each of which is accessible to the processor 110. The fluid analytics module 120 can include additional computer resource assets, in addition to 120A-120C. The computer resource assets, including 120A, 120B, 120C, can each include a computing device, or can be integrated in a single computing device, or can be configured as one or more computer resources that are executable by the processor 110. The computer resources can be stored in and retrieved from, for example, the storage 130 and/or the memory circuitry 20 (shown in FIG. 1).

In various embodiments, the fluid analytics module 120 can include one or more physics-based approaches, including, for example, one or more computer resource assets configured to perform calculations based on Manning's equation, Hazen Williams equation, or other suitable equations, including hydraulic or Continuity equations. In certain embodiments, the computer resource assets include computer programs that, when executed by the processor 110, cause the processor to perform the physics-based calculations, including providing an estimated flowrate based on input water depth, sensor height, sample rate, outgoing pipe diameter, outgoing pipe slope, and/or outgoing pipe roughness coefficient. In an embodiment the computer resource assets can include a Micropython or Python script for providing the estimated flowrate.

In certain embodiments, the fluid analytics module 120 can, as an alternative or in addition to the physics-based computer resource assets, include one or more machine learning (ML) platforms, including one or more supervised machine learning systems and one or more unsupervised machine learning systems. The ML platform can include one or more ML models trained to estimate flowrate and velocity of a fluid based on, for example, pipe attributes and both prior and real-time flow depth measurements. In various applications, either or both the physics-based and/or the ML model-based approaches provide significantly more accurate estimates than state of the art technologies for flowrate in conditions, such as, for example, surcharge conditions, and avoid the tendency of such technologies to default to maximum or full flow capacity estimates when fluid levels exceed the pipe crown. Additionally, the ML model(s) can adapt more effectively to other complex flow conditions, such as turbulence or irregular pipe geometry. The ML platform can be configured to continuously (or periodically) update parametric values and refine predictions based on incoming sensor data from the sensors 40, improving real-time accuracy compared to static equations. For instance, the trained ML model executed on, for example, the processor 110, can estimate flowrate based on real-time, simulated, or historical flowrate and flow depth measurements, outgoing pipe attributes, real-time sensor data, and trained hydrodynamic patterns. The ML model can adapt to variations in flow conditions, including turbulence, irregular pipe geometry, and surcharging, where traditional physics-based equations may have limitations.

In various embodiments the fluid analytics module 120 can include computer resources arranged to receive inputs, such as, for example, the sensor height above a channel bottom, the sample rate, the diameter of the outgoing pipe, the slope of the outgoing pipe, and a roughness coefficient, and calculate flowrate and/or flow velocity using physics-based approaches such as Hazen-Williams or Manning's equations and/or one or more trained ML models. Each estimate provided by a ML model can include a predicted flowrate value and/or a predicted flow velocity value. The ML model can provide a value certainty score for each of the predicted flowrate value and flow velocity value. The value certainty score is representative of likelihood of the estimated value predicted by the ML model.

For instance, in one non-limiting embodiment, the trained ML model is executed on the processor 110 to estimate a flow velocity value and a flowrate value based on historical and real-time flow depth measurements and outgoing pipe attributes to improve prediction accuracy in complex hydraulic conditions. The ML model can refine its predictions over time, learning from observed depth-to-flow relationships and accounting for factors such as sediment accumulation, non-uniform pipe roughness, surcharging, and varying flow conditions.

In certain applications, the flow velocity value can include a magnitude value (for example, speed in meters/second) and a vector value (for example, one or more values indicative of direction of flow); and the flowrate value can include a volume of fluid (for example, in gallons, cubic meters, cubic feet, or the like) travelling past or through a point over a specific period of time.

The fluid analytics module 120 can implement the ML models to estimate flowrate by analyzing sensor data patterns, adjusting for environmental variations, and learning from historical flow measurements. The ML model(s) can compensate for limitations in physics-based approaches (including, for example, hydraulic equations), such as, for example, inaccuracies caused by variable sediment deposition, turbulence, surcharging, and irregular pipe geometries. The ML model can refine its predictions over time by integrating new sensor data, allowing for adaptive and improved accuracy in flow estimation.

In various embodiments the controller 10 can be arranged as depicted in FIG. 3. The fluid analytics module 120 can include a fluid flow velocity unit 120A, a fluid flowrate unit 120B, and a historical fluid data analyzer 120C. The fluid flow velocity unit 120A can be configured to calculate the velocity (including magnitude and direction) of a fluid according to the processes described herein, including physics-based and/or ML-based approaches. The fluid flowrate unit 120B can configured to calculate the rate of flow of fluid according to the processes described herein, including physics-based and/or ML-based approaches. The historical fluid data analyzer 120C is configured to communicate with the storage 130 (for example, DB 130D) and retrieve historical data, including historical fluid velocity data, fluid rate data, fluid depth data, and the times at the corresponding fluid velocities, fluid rates, and fluid depths were measured. The historical fluid data analyzer 120C can be arranged to analyze the historical flow data, including historical flow velocity and flowrate data in a given installation and interact with the fluid velocity unit 120A and fluid flowrate unit 120B to facilitate estimates by the ML model(s) of the fluid flow velocity and fluid flowrate across time, including at any time in the past, present and future. Each of the fluid flow velocity unit 120A and fluid flowrate unit 120B can include selectable, either or both, physics-based and ML-based approaches.

The fluid flow velocity unit 120A can include one or more computer resources that are physics-based and selectable to calculate a fluid flow velocity using a Hazen-Williams equation, a Manning's equation, or other suitable physics-based approach or technology as will be understood by those skilled in the art. The fluid flow velocity unit 120 can further (or alternatively) include one or more ML platform, including a supervised ML system and/or an unsupervised ML system. The ML platform can include Feedforward Neural Networks, Recurrent Neural Networks (RNNs), Long Short-Term Memory (LSTM) networks, Multilayer Perceptrons (MLPs), Deep Neural Networks (DNN), a Convolutional Neural Network (CNN), a Deep Convolutional Neural Network (DCNN) Linear Regression, Random Forest Regression, Support Vector Regression, Gradient Boosting Machines (e.g., XGBoost, LightGBM), or other ML platform. In an embodiment the ML platform includes a lightweight Random Forest Regression model, as it provides accuracy with computational efficiency and ease of deployment. The ML model(s) is built and trained to estimate the fluid flow rate based on received data such as, for example, fluid depth, sensor height, sample rate, outgoing pipe diameter, outgoing pipe slope, and/or outgoing pipe roughness coefficient. The choice of physics-based and/or ML-based computer resource(s) can depend on the environment, application and/or specific characteristics of the dataset and the complexities of the relationships between the input variables.

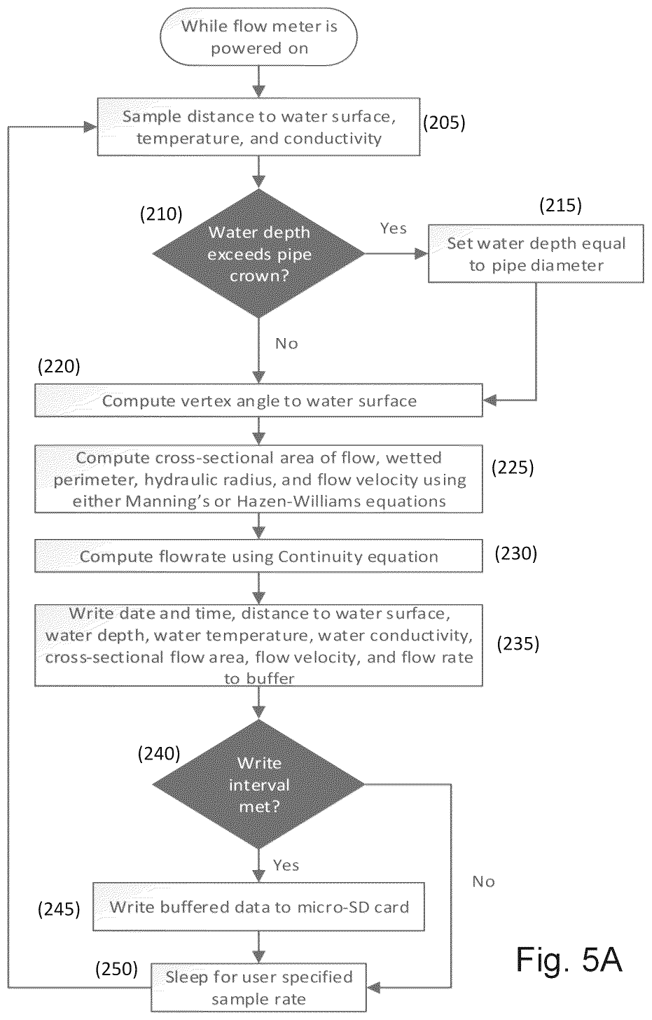

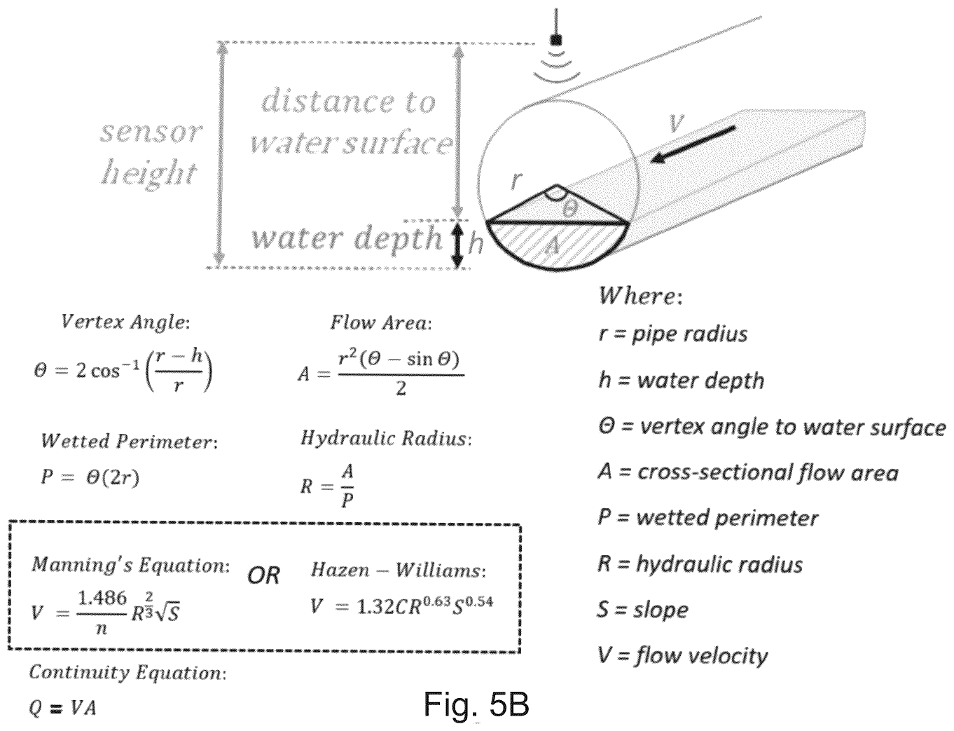

In an embodiment, the Manning's equation approach can be selected to calculate the fluid velocity V according to Equation 1:

$$V = \frac{1.486}{n} {R}^{\frac{2}{3}} \sqrt{S} \qquad ( Equation 1 )$$

where Vis the flow velocity (m/s), R is the hydraulic radius m is the slope of the energy grade line (dimensionless), and n is the Manning's roughness coefficient. An embodiment of an implementation of the Manning's equation is shown in FIG. 5B.

The hydraulic radius R is calculated according to Equation 2:

$$R = \frac{A}{P} \qquad ( Equation 2 )$$

where A is the cross-sectional flow area and P is the wetted perimeter. An embodiment of an implementation of the hydraulic radius equation is shown in FIG. 5B.

The wetted perimeter P is calculated according to Equation 3:

$$P = Θ ( 2 r ) \qquad ( Equation 3 )$$

where Θ is the vertex angle to fluid surface and r is the pipe radius. An embodiment of an implementation of the wetted perimeter equation is shown in FIG. 5B.

The vertex angle Θ is calculated according to Equation 4:

$$Θ = 2 {cos}^{- 1} ( \frac{r - h}{r} ) \qquad ( Equation 4 )$$

where h is the fluid depth. An embodiment of an implementation of the Manning's equation is shown in FIG. 5B. An embodiment of an implementation of the vertex angle equation is shown in FIG. 5B.

Alternatively, the fluid velocity V can be calculated according to the Hazen-Williams approaching, according to Equation 5:

$$V = 1.32 C {R}^{0.63} {S}^{0.54} \qquad ( Equation 5 )$$

where C is the Hazen-Williams roughness coefficient. An embodiment of an implementation of the Hazen-Williams equation is shown in FIG. 5B.

The Continuity equation, based on the conservation of mass in fluid flow, states that the volumetric flowrate (Q) is equal to the product of the flow velocity (V) and the cross-sectional area of flow (A). In the context of this disclosure, the Continuity equation is used to estimate flowrate as:

$$Q = V A \qquad ( Equation 6 )$$

where Q is the flowrate (e.g., cubic feet/second), V is the flow velocity (feet/second), and A is the cross-sectional flow area (square feet). This formulation is applied after calculating or predicting the velocity of the fluid in the channel.

The flowrate Q can be calculated based on volumetric change over time, for example, according to the following equation:

$$Q = Vol . / Δ t \qquad ( Equation 7 )$$

$$Vol . = Δ h \cdot A \qquad ( Equation 8 )$$

where Q is flowrate, Vol. is the wet well cross-sectional area A multiplied by the change in fluid depth Δh, Δt is change in time (for example, Δt=t₂−t₁, where t₁ and t₂ are first time and second time instances, respectively), and Δh is change in height of the fluid depth (for example, Δh=h₂−h₁, where h₁ and h₂ are first and second heights, respectively, in depth of the fluid).

The fluid flow velocity unit 120A can include one or more ML models trained to estimate flow velocity of a fluid based on attributes similar to, for example, those used for the Manning's, Hazen-Williams, and Continuity equations—that is, pipe or channel diameter, pipe or channel slope, pipe or channel roughness, and flow depth measurements. The attributes can include pipe attributes and both historical and real-time flow depth measurements. The ML model-based approach can provide significantly more accurate estimates than state of the art technologies for flow velocity and/or flowrate in conditions, such as, for example, surcharge conditions, and avoid the tendency of such technologies to default to maximum or full flow capacity estimates when fluid levels exceed the pipe crown

The fluid flowrate unit 120B can be provided as a separate computer resource as seen in FIG. 3, or it can be integrated into the fluid flow velocity unit 120A. The fluid flowrate unit 120B is arranged to calculate a fluid flowrate based on the fluid flow velocity calculated and/or predicted by the fluid velocity unit 120A. Given cross-sectional area of flow A in a pipe or channel, and fluid velocity V, the fluid flowrate can be calculated using the continuity Equation 6 (above).

In various embodiments the trained ML model(s) can be utilized to provide real-time flowrate estimation based on current and prior sensor readings. The ML model(s) can be periodically retrained with newly collected data, improving accuracy of predicted values over time as environmental conditions change. By recognizing patterns in historical and live real-time data, the ML model can refine its flow predictions in conditions where physics-based models alone may introduce greater uncertainty.

FIG. 4 shows a process for building, training, testing, and tuning the ML model in the fluid analytics module 120 (shown in FIG. 3). Initially, data such as, for example, historical timeseries data, pipe attribute data, and hydraulic model simulation data, can be received from one or more data sources 121. In an embodiment, the data ingested at 121 can be retrieved from the memory circuitry 20 (shown in FIG. 1) or the storage 130 (shown in FIG. 3). The historic timeseries data can include, for example, fluid flow data, fluid depth data, fluid velocity data, and fluid temperature data. The pipe attribute data can include, for example, pipe diameter, slope of pipe, roughness, and material makeup of pipe. The hydraulic model simulation data can include, for example, simulated fluid flow, simulated fluid depth, and simulated fluid velocity in pipes with varying attributes.

The data received can be cleaned and/or annotated to build one or more training datasets and one or more testing datasets 122. At 122: feature names can be standardized and outliers and missing records removed; meaningful predictors can be selected, including pipe diameter, pipe slope, pipe roughness, current fluid depth, previous fluid depth; and datasets can be merged into one or more dataframes for model training and testing.

The dataframe can then be implemented to train and test one or more ML models at 123. In the case of supervised learning, the ML model can be trained using labeled datasets (including, for example, fluid flowrate and/or fluid velocity used as target variables). Model performance can be evaluated on unseen data points to validate and test the ML model. The trained ML model object can be exported for use on a computing device such as the one or more computing devices included in certain embodiments of the fluid analytics module 120 or on one or more computer resource assets in the fluid analytics module 120 for execution on the processor 110.

At 124, the trained model object is loaded into the controller 10 of the flow meter apparatus 1 (shown in FIG. 1) and readied for implementation in estimating fluid flow velocity and fluid flowrate. The apparatus 1 can be installed in an environment such as, for example, a sewer manhole, and an ultrasonic depth sensor (for example, 40 shown in FIG. 1 or FIG. 2C) can be positioned and installed, for example, above an outgoing pipe crown. The apparatus 1 can be turned ON and, at 125, the controller 10 will estimate fluid flow, including fluid flow velocity and fluid flowrate, based on the physics-based calculations or ML-based predictions described above. The ML model can be arranged to auto-tune and update parametric values at 126 based on the output estimates.

In certain embodiments the physics-based calculations and ML-based predictions performed by the fluid analytics module 120 can be selectable. In an embodiment the physics-based approaches and/or ML-based apparatus can be selected automatically by the processor 110 based on received real-time input data and corresponding historical data to provide estimated fluid flow values with confidence scores greater than 90%, preferably greater than 95%, and more preferably greater than 99%. ML model predictions can be cross-checked with flow estimated using the physics-based approaches for validation and continuous learning. The fluid analytics module 120 can be configured such that ML models continuously (or periodically) learn as real-time data is collected to improve accuracy.

The controller 100 can include a non-transitory computer-readable storage medium that can hold executable or interpretable computer resources, including computer program code or instructions that, when executed by the processor 110, cause the steps, processes or methods in this disclosure to be carried out. The computer-readable storage medium can be contained in the storage 130 and/or the memory circuitry 20 (shown in FIG. 1).

The storage 130 can include a read-only memory (ROM) 130A, a random-access memory (RAM) 130B, a hard disk drive (HDD) 130C, and a database (DB) 130D. The storage 130, including computer-readable media, can be configured to provide nonvolatile storage of data, data structures, and computer-executable instructions (or computer program code). The storage 130 can accommodate the storage of any data in a suitable digital format. The storage 130 can include computing resources that can be used to execute aspects of the architecture included in the controller 100, including, for example, a program module, an application program, an application program interface (API), or program data.

As discussed above, the storage 130 can hold historical flow data, including flow depth, flow velocity, and flowrate measurements. The historical data can be retrieved and used to train or retrain and tune the ML model to improve prediction accuracy over time. As new flow conditions are observed, the ML model can be updated to better capture dynamic hydraulic behavior, leading to more reliable flow estimations under varying conditions.

In a non-limiting embodiment, the storage 130 can contain computer resources that are executable on the processor 110 to carry out the processes and functions disclosed herein. One or more of the computing resources can be cached in the RAM 130B as executable sections of computer program code or retrievable data.

In various embodiments, the computing resources can include an API such as, for example, a web API, a simple object access protocol (SOAP) API, a remote procedure call (RPC) API, a representation state transfer (REST) API, or any other utility or service API.

A basic input-output system (BIOS) can be stored in the non-volatile memory in the storage 130, such as, for example, the ROM 130A. The ROM 130A can include, a ROM, an erasable programmable read-only memory (EPROM), or an electrically erasable programmable read-only memory (EEPROM). The BIOS can contain the basic routines that help to transfer information between any one or more of the components in the CRS system 100 such as during start-up.

The RAM 130B can include a dynamic random-access memory (DRAM), a synchronous dynamic random-access memory (SDRAM), a static random-access memory (SRAM), a non-volatile random-access memory (NVRAM), or another high-speed RAM for caching data.

The HDD 130C can include, for example, a solid-state drive (SSD) or any suitable hard disk drive for use with big data. The HDD 130C can be configured for external use in a suitable chassis (not shown). The HDD 130C can be arranged to connect to the bus (not shown) via a hard disk drive interface (not shown).

The DB 130D can be arranged to be accessed by any one or more of the components in the controller 100, including the fluid analytics module 120. The DB 130D can be arranged to receive a query and, in response, retrieve specific data, data records or portions of data records based on the query, including historical fluid flow velocity data and flowrate data for a given installation. A data record can include, for example, a file or a log. The DB 130D can include a database management system (DBMS) that can interact with the components in the controller 100. The DBMS can include, for example, SQL, NoSQL, MySQL, Oracle, Postgress, Access, or Unix. The DB 130D can include a relational database.

The interface suite 140 can include one or more input-output (IO) interfaces 140A and one or more network interfaces 140B. The interface suite 140 can be configured to receive, transmit or exchange data and command signals with any communicating device in an implementation or network.

The input-output (IO) interface 140A can be arranged to receive instructions or data from an operator. The IO interface 140A can be arranged to receive and transmit speech content, commands or data from (or to) an operator.

In various embodiments the IO interface 140A is arranged to connect to or communicate with one or more input-output devices, including, for example, the HMI discussed above, which can include, a keyboard, a mouse, a pointer, a stylus, a microphone, a speaker, an interactive voice response (IVR) unit, a graphic user interface (GUI), or a display device.

The IO interface 140A can include one or more audio drivers (not shown) and one or more video drivers (not shown). In various embodiments, the audio driver can include a sound card, a sound driver, an interactive voice response (IVR) unit, or any other device necessary to render a sound signal on a sound production device, such as for example, a speaker. The video driver can include a video card, a graphics driver, a video adaptor, or any other device necessary to render an image signal on a display device.

The network interface 140B can be arranged to communicate via one or more communication links with the sensor(s) 40 (shown in FIG. 1) and one or more communicating devices (not shown) and exchange data and instructions. In various embodiments the network interface 140B can be arranged to communicate with the sensors(s) 40 and/or the communicating device(s) directly or via the network 50 (shown in FIG. 1). The network interface 140B can be arranged to connect to the Internet or any wired and/or wireless network or communicating device.

The network interface 140B can include a modem, a transmitter, a receiver or a transceiver. The network interface 140B can include a wired or a wireless communication network interface. When used in a local area network (LAN), the network interface 140B can be arranged to include a wired or wireless communication network interface that can connect to the LAN; and, when used in a wide area network (WAN), the network interface 140B can be arranged to include a modem to connect to the WAN network. The modem can be internal or external and wired or wireless. The modem can be connected to the bus via, for example, a serial port interface.

The communications unit 150 can include a transmitter, a receiver or a transceiver. The communications unit 150 can be arranged to communicate directly via one or more communication links with the sensor(s) 40 (shown in FIG. 1) and communicating devices (not shown) or via the network interface 140B. Electronic signals, including data signals and command signals, can be communicated or exchanged between the controller 100 and any sensor 40 and/or external communicating device (not shown) either directly via the communications unit 150 or by way of the network interface 140B. The communications unit 150 can receive, for example, sensor signals from various sensors 40, including an ultrasonic depth sensor, a temperature sensor, a conductivity sensor, a gas level sensor, a camera, and a raindrop sensor. The communications unit 150 can further receive servo motor feedback signals and send control signals to one or more servo motors, for example, to move, tilt, and pan the camera along an x-axis, a y-axis, and/or a z-axis in the Cartesian coordinate system.

The sensor suite 160 can include a depth sensor unit 160A, a temperature sensor unit 160B, a conductivity sensor unit 160C, a gas sensor unit 160D, and an image sensor unit 160E. In the embodiment depicted in FIG. 3, the depth sensor unit 160A can include the ultrasonic sensor control board and the temperature sensor unit 160B can include the temperature sensor control board. The sensor suite 160 can include additional sensor units (not shown), including a raindrop sensor unit (not shown), each of which can be configured to interact with one or more respective external sensor devices 40 (shown in FIG. 1). For example, the image sensor unit 160E can be configured to interact with and exchange data and instructions with the camera 40 and one or more servo motors coupled to the camera, so as to operate and move, pan, and tilt the camera along the x-, y-, and z-axes, open and close a camera lens cover, and record video footage of the field of view of the camera, which can include, for example, a manhole, to document inflow and infiltration, validate flow depth, and potentially document illicit discharge. The image data can be analyzed by a ML model (for example, CNN-based model) to detect and identify such events. The raindrop sensor unit (not shown) can be configured to interact with and control the raindrop sensor to provide real-time raindrop measurement signals.

Each of the units 160A to 160E can be configured to interact with and exchange data and instructions with a corresponding respective sensor 40 in an installation, including an ultrasonic depth sensor, a temperature sensor, a conductivity sensor, and a gas sensor to receive, respectively, real-time depth measurement, temperature measurements, conductivity measurements, and gas measurements of the fluid and surrounding area. The units 160A to 160E can be configured to interact with respective sensors 40 such that real-time measurement data signals are received by the controller 10 from the sensors 40.

FIG. 5A shows an embodiment of an operation of the controller 10 (for example, shown in FIGS. 1, 2, and 3) for calculating water flow in a sewer environment; and FIG. 5B shows examples of implementation of the Manning's equation, Hazen-Williams equation, and Continuity equations according to an embodiment. While the flow meter apparatus 1 (shown in FIG. 1) is powered ON, measurements are performed by an ultrasonic depth sensor 40, a temperature sensor 40, and a conductivity sensor 40, and sampled measurement data received by the controller 10 (at Step 205). A determination is made by the controller 10 whether the water depth exceeds the pipe crown (Step 210). If it is determined that the water depth does not exceed the pipe crown (YES at Step 210), then (NO at Step 210) the water depth is set equal to the pipe diameter (Step 215).

The process then proceeds to calculate or retrieve values (for example, by the controller 10, shown in FIGS. 1-3) for the vertex angle to the water surface (Step 220) and cross-sectional area of flow, wetted perimeter, hydraulic radius, and flow velocity using either the above discussed physics-based approach or ML-based approach (Step 225). The fluid velocity having been calculated (for example, by the controller 10) the flowrate can then be calculated (for example, by the controller 10) using, for example, the Continuity equation (Step 230). The event data, including all variables, can be stored in the storage 130 (shown in FIG. 3), including the date, time, distance to water surface, water depth, water temperature, water conductivity, cross-sectional flow area, flow velocity, and flowrate.

In an embodiment, the process can include periodic storage of the event data in the memory circuitry 20 (shown in FIG. 1). In the embodiment, the storage of the event data to the memory circuitry 20 can be based on a predetermined schedule, such as, for example, hourly, daily, weekly, or monthly. In this regard, a determination can be made whether a write time interval is met (Step 240) and, if so (YES, at Step 240), the event data is copied or written to the memory circuitry 20 (for example, containing a micro-SD card) (Step 245). If the write interval is not met (NO, at Step 240), and after copying/writing the event data to the memory circuitry 20 (Step 245), the flow meter apparatus 1 can enter a sleep mode to conserve energy (Step 250). The sleep mode can be based on a user-defined sample rate.

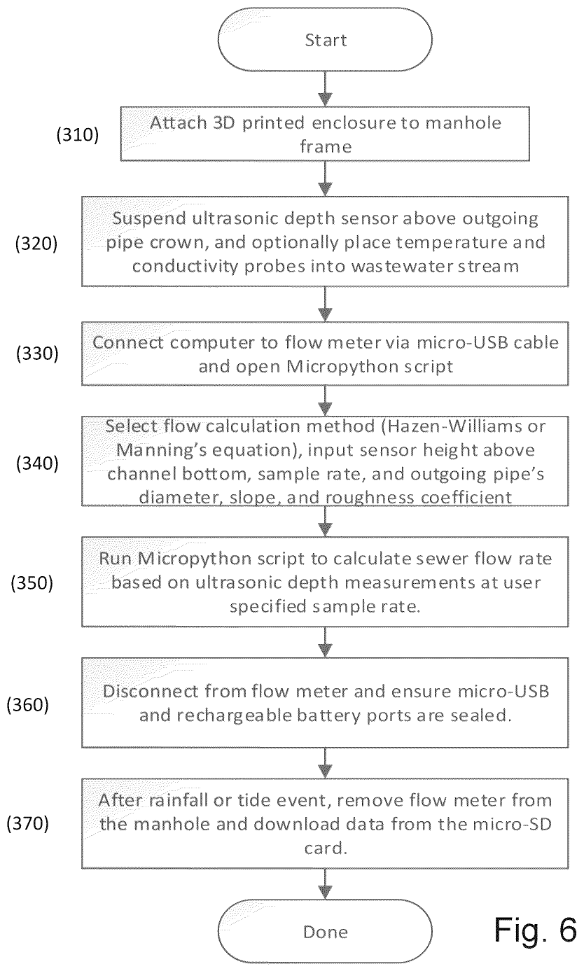

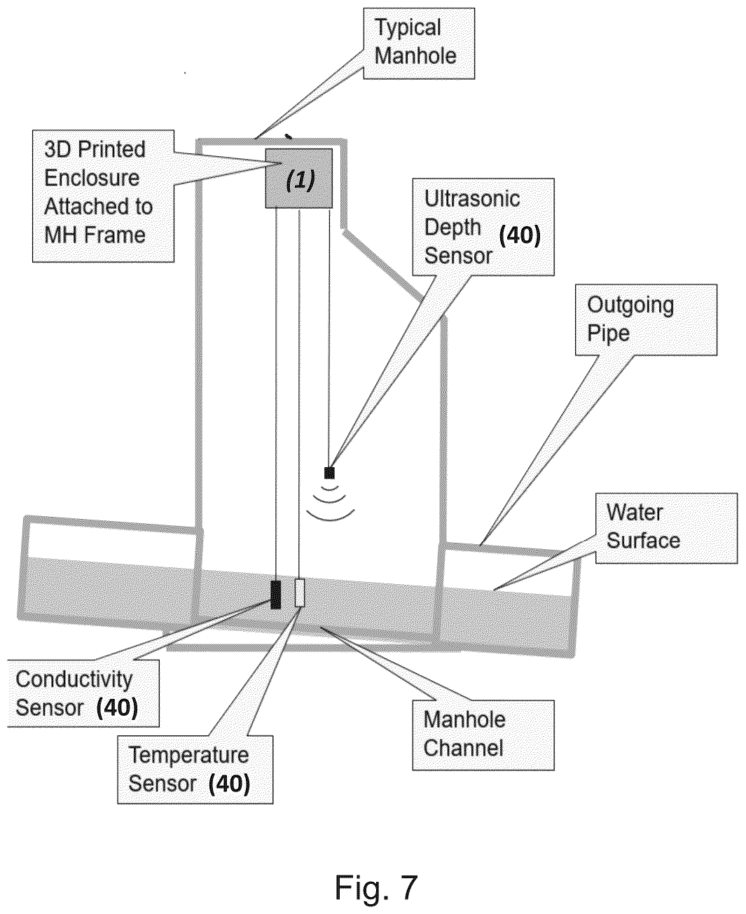

FIGS. 6 and 7 illustrate non-limiting embodiments of a process and installation of the flow measurement system 1 in a sewer. Referring to the FIGS. 6 and 7 contemporaneously, initially the housing 11 (shown in FIG. 1 or 2) containing the flow meter apparatus 1 can be attached to a structure such as, for example, a manhole frame (Step 310). An ultrasonic depth sensor 40 can be suspended above an outgoing pipe crown and, optionally, temperature and conductivity sensors 40 can be placed in the wastewater stream (Step 320). The flow meter apparatus 1 (shown in FIG. 1) can be connected to an external computing device (not shown) via, for example, a micro-USB cable and the controller 10 (shown in FIG. 1) can be enabled to operate (Step 330). The controller 10 can select a calculation method from a plurality of available methods, including Hazen-Williams or Manning's equation, to calculate a fluid velocity (Step 340). The calculation is based on the input sensor height above the channel bottom, the sample rate, and the outgoing pipe's diameter, slope, and roughness coefficient. The controller 10 can then calculate the sewer flowrate (for example, by running a Micropython, Python, or other script) based on the ultrasonic depth measurements at the set sample rate (Step 350). The micro-USB cable can be disconnected from the flow measurement apparatus 1 and all ports sealed (Step 360). After a rainfall or tide event, the flow meter apparatus 1 can be removed from the manhole and data downloaded from the memory circuitry 20 (shown in FIG. 1) (Step 370).

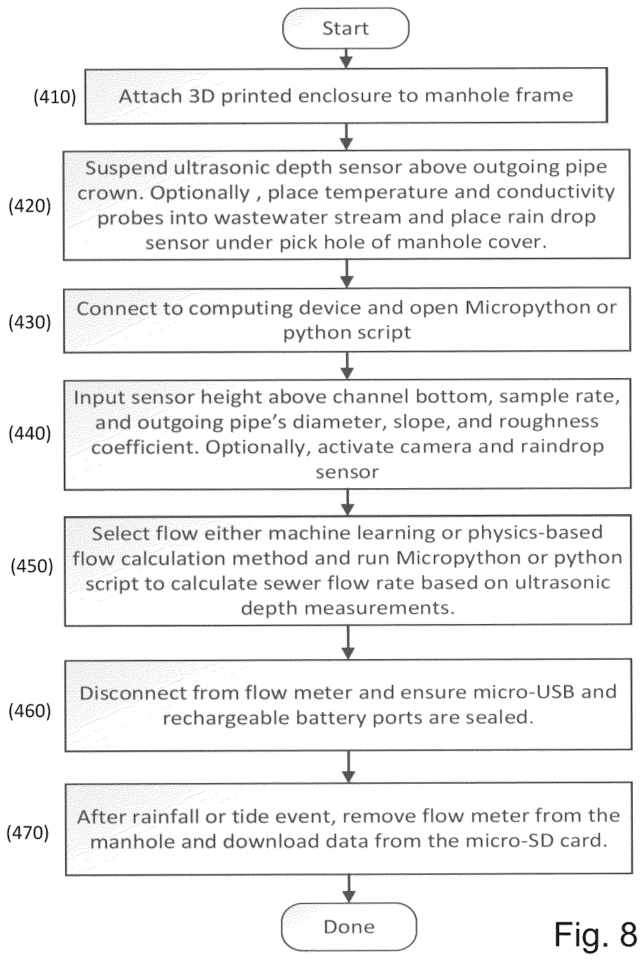

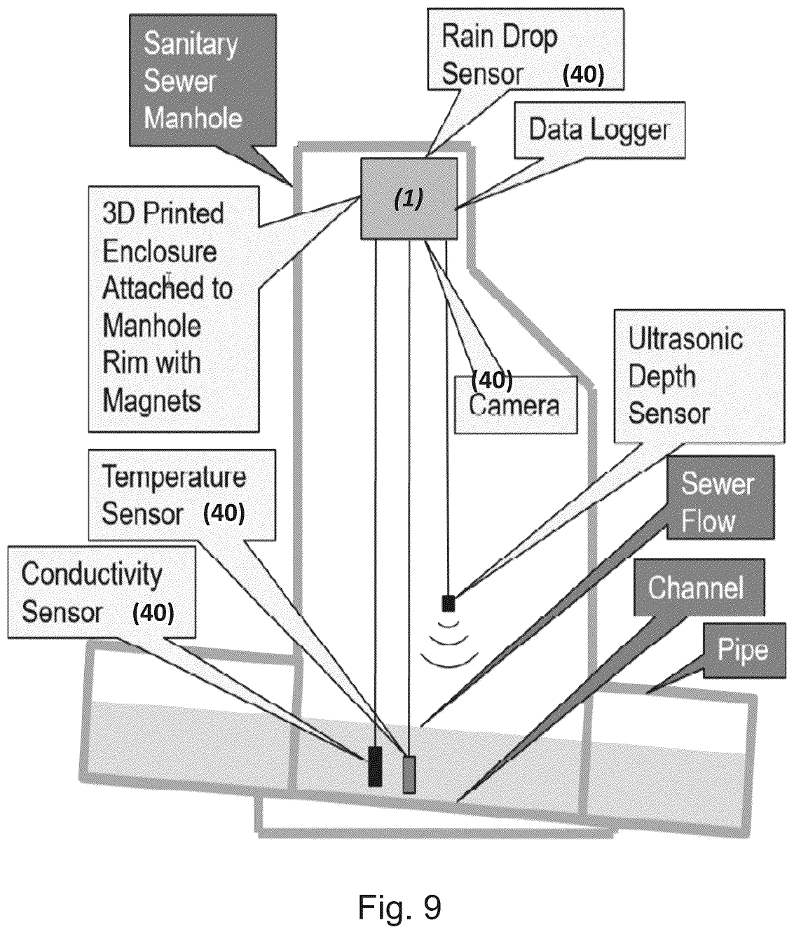

FIGS. 8 and 9 illustrate additional non-limiting embodiments of a process and installation of the flow measurement system 1 in a sewer. Referring to the FIGS. 8 and 9 contemporaneously, initially the housing 11 (shown in FIG. 1 or 2) can be attached to a structure such as, for example, a manhole frame (Step 410). An ultrasonic depth sensor 40 can be suspended above an outgoing pipe crown and, optionally, temperature and conductivity sensors 40 can be placed in the wastewater stream and rain drop sensor under the pick hole of the manhole cover (Step 420). The flow meter apparatus 1 (shown in FIG. 1) can be connected to an external computing device (not shown) via, for example, a micro-USB cable and the controller 10 (shown in FIG. 1) can be enabled to operate (Step 430). The controller 10 can receive as inputs, for example, from a user operating the external computing device, the input sensor height above channel bottom, the sample rate (for example, every second, minute, hour, day, week, or month), and properties of the outgoing pipe, including diameter, slope, and roughness coefficient (Step 440). At Step 440, a camera and raindrop sensor can be activated.

In various embodiments the user (via the external computing device) or the controller 10 automatically can select either (or both) a physics-based flow calculation method or an ML-based flow calculation method to calculate the sewer flowrate, including based on depth measurements (Step 450). The physics-based approach can include running Micropython or Python scripts to calculate the sewer flowrate.

The micro-USB cable can be disconnected from the flow measurement apparatus 1 and all ports sealed (Step 460). After a rainfall or tide event, the flow meter apparatus 1 can be removed from the manhole and data downloaded from the memory circuitry 20 (shown in FIG. 1) (Step 470).

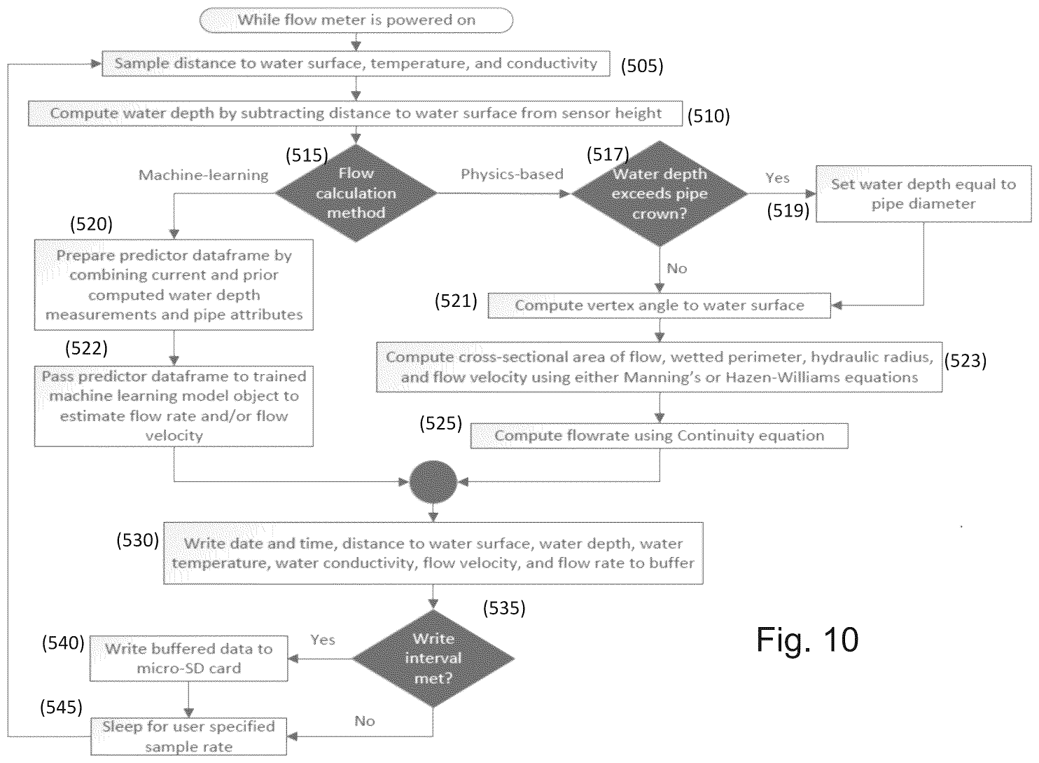

FIG. 10 illustrates an embodiment of a process for calculating flow velocity and flowrate in an environment such as, for example, in the installation depicted in FIG. 9. Referring to FIGS. 9 and 10 contemporaneously, after the flow meter system is installed, the flow meter apparatus 1 is powered ON and the controller 10 (shown in FIGS. 1-3) receives measurement signals from the sensors 40, including distance to the water surface, temperature of the water, and conductivity of the water (Step 505). In an embodiment the controller 10 and sensors 40 are configured to save power by the controller 10 sending instructions to each of the sensors 40 to take measurements and send measurement data to the controller 10 according to a predetermined schedule or sample rate, such as, for example, every x seconds, minutes, hours, or days, where x is a positive real number greater than 0.

The water depth can be calculated (for example, by the controller 10) by subtracting the distance to the water's surface from the height of the depth sensor 40 location (Step 510). A determination can be made whether to use a ML-based method or a physics-based method to calculate fluid flow characteristics (Step 515). The selection of ML-based or physics-based method can be made by the controller 10 automatically based on at least the received measurement data or in response to an operator selection or input, such as, for example, via a HMI.

If the ML-based method is selected (ML at Step 515), then an ML model is selected for implementation (Step 520). In this regard, a predictor dataframe can be prepared by combining current (or real-time) and historical computed water depth measurements and pipe attributes (Step 520). The predictor dataframe can be supplied to the trained ML model to estimate (or predict) the flowrate and/or flow velocity of the water or wastewater (shown in FIG. 9) (Step 522). The output(s) of the ML model can include an estimated (or predicted) flowrate and/or flow velocity, as well as a confidence score for each or both values. The output(s) can also be feedback to the ML platform (for example, fluid flow velocity unit 120A and/or fluid flowrate unit 120B, shown in FIG. 3) for tuning of the ML model, for example, by updating parametric values of the ML model. The measurement data and ML model output(s) can be stored in the storage 130 (shown in FIG. 3), including the date, time, distance to water surface, water depth, water temperature, water conductivity, flow velocity, and flowrate (Step 530).

If the physics-based method is selected (physics-based at Step 515), then a determination is made regarding the depth of the water with respect to the pipe crown (Step 517). If it is determined that the water depth does not exceed the pipe crown (NO at Step 517), then the vertex angle to the water surface is calculated (for example, by the controller 10) (Step 521), otherwise (Yes at Step 517) the water depth value is set equal to the pipe diameter value (Step 519) and the vertex angle calculated (Step 521). Values can be computed (or retrieved from storage 130, shown in FIG. 3) by the controller 10 for the cross-sectional area of flow, wetted perimeter, and hydraulic radius (Step 523). Using the Manning's equation or the Hazen-Williams equation, the controller 10 can calculate the flow velocity of the water or wastewater (for example, shown in FIG. 9). Then, based on the calculated flow velocity, the flowrate of the water/wastewater can be calculated using the Continuity equation (Step 525). The measurement data and calculation data can be stored in the storage 130 (shown in FIG. 3), including the date, time, distance to water surface, water depth, water temperature, water conductivity, flow velocity, and flowrate (Step 530).

The controller 10 can be configured to copy the logged data, including the measurement data, calculation data, and/or ML output data for each sample event (for example, stored in the storage 130, shown in FIG. 3) and periodically write the logged data to the memory circuitry 20 (shown in FIG. 1) or an external computing device (not shown) (Step 540). To save power, the controller 10 can be configured to store the logged data according to a predetermined schedule and when a write interval is met (Yes at Step 535) write the logged data to the memory circuitry 20 (Step 540), otherwise (No at Step 535) set the flow meter apparatus 1 to a sleep mode (Step 545) until the next sample event according to the sample rate set by, for example, the user.

The terms “a,” “an,” and “the,” as used in this disclosure, means “one or more,” unless expressly specified otherwise.

The term “backbone,” as used in this disclosure, means a transmission medium or infrastructure that interconnects one or more computing devices or communication devices to provide a path that conveys data packets and instruction signals between the one or more computing devices or communication devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” or “communication device,” as used in this disclosure, mean any computing device, hardware, or computing resource that can transmit or receive data packets, instruction signals or data signals over a communication link. The communicating device or communication device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, 5G, or 6G cellular standards, satellite, or Bluetooth. A communication link can include, for example, an RS-232, RS-422, RS-485, or any other suitable interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device,” or “processor” can include, for example, without limitation, a processor, a microprocessor (C), a central processing unit (CPU), a graphic processing unit (GPU), a data processing unit (DPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, Cs, CPUs, GPUs, ASICs, general purpose computers, super computers, personal computers, laptop computers, palmtop computers, notebook computers, desktop computers, workstation computers, or servers.

The terms “computer resource” or “computing resource,” as used in this disclosure, mean software, a software application, a web application, a web page, a computer application, a computer program, computer code, machine executable instructions, firmware, artificial intelligence platform or model, machine learning platform or model, or a process that can be arranged to execute on a computing device or a communicating device.

The terms “computer resource asset” or “computing resource asset,” as used in this disclosure, means a computing resource, a computing device, a communicating device, or any combination of thereof.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, 5G, or 6G cellular standards, or Bluetooth.

The terms “computer resource process” or “computing resource process,” as used in this disclosure, mean a computing resource that is in execution or in a state of being executed on an operating system of a computing device (for example, flow meter apparatus 1, shown in FIG. 1) or one or more of the computer resource assets in controller 10 (shown in FIG. 3), including, for example, for real-time execution of one or more ML models for flow estimation, pattern recognition, or predictive analytics. Each computing resource that is created, opened, or executed on or by the operating system can create a corresponding computing resource process. A computing resource process can include one or more threads, as will be understood by those skilled in the art.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can also store training data for a ML model, including historical flow measurements, sensor readings, and environmental conditions, to improve real-time predictive analytics. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and variations thereof, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run at least one computing resource, often under heavy workloads, unattended, for extended periods of time with minimal or no human direction. The server can include a plurality of computers configured, with the at least one computing resource being divided among the computers depending upon the workload. For example, under light loading, at least one computing resource can run on a single computer. However, under heavy loading, multiple computers can be required to run the at least one computing resource. The server, or any if its computers, can also be used as a workstation.

The terms “transmission,” “transmit,” or “send,” as used in this disclosure, mean the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include air, coaxial cables, copper wire, or fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for measuring or estimating properties of a fluid including at least one of a fluid velocity and a fluid flowrate, the system having an apparatus comprising:
a processor arranged to perform at least one of a physics-based calculation and a machine learning-based estimation;
a memory arranged to store data; and
a communications unit arranged to receive one or more sensor signals from corresponding one or more sensors positioned in the fluid or in an area outside the fluid, including a depth sensor that is arranged above a surface of the fluid,
wherein the processor is arranged to calculate at least one of a fluid velocity and a fluid flowrate using at least one of the physics-based calculation and the machine learning-based estimation.

2. The system in claim 1, wherein the memory is arranged to store computer program instructions that, when executed by the processor, perform at least one of the physics-based calculation and the machine learning-based estimation.

3. The system in claim 2, wherein the physics-based calculations comprise a Manning's calculation or a Hazen-Williams calculation to calculate the fluid velocity.

4. The system in claim 2, wherein the machine learning-based estimation comprises predicting by a trained machine learning model the fluid velocity and/or fluid flow rate based on at least one of:
a diameter of a pipe or a channel;
a depth of a fluid in the pipe or the channel;
a vertex angle to the surface of the fluid;
a cross-sectional flow area of the pipe or the channel;
a wetted perimeter;
a hydraulic radius;
a slope of the pipe or the channel; and
a roughness coefficient of the pipe or the channel.

5. The system in claim 2, wherein the computer program instructions include instructions that, when executed by the processor, perform a Continuity calculation to calculate the flowrate.

6. The system in claim 1, further comprising the depth sensor, wherein:
the depth sensor includes an ultrasonic sensor positionable inside a manhole above a crown of an outgoing pipe;
the ultrasonic sensor is positionable in the area outside the fluid and arranged to measure a distance to a surface of the fluid without direct contact with the fluid and send depth measurement data to the processor; and
the one or more sensor signals include the depth measurement data.

7. The system in claim 1, further comprising:
a temperature sensor arranged to measure temperature of the fluid and send temperature measurement data to the processor,
wherein the one or more sensor signals include the temperature measurement data.

8. The system in claim 7, where the processor is arranged to detect presence of an inflow or an infiltration of the fluid based on the temperature measurement data.

9. The system in claim 1, further comprising:
a conductivity sensor arranged to detect presence of saltwater within the fluid and send conductivity measurement data to the processor,
wherein the one or more sensor signals include the conductivity measurement data.

10. The system in claim 1, further comprising:
a gas sensor arranged to measure one or more gases in the area outside the fluid and send gas measurement data to the processor,
wherein the one or more sensor signals include the gas measurement data.

11. The system in claim 10, wherein the one or more gases include methane gas and the gas measurement data includes a methane gas level value representative of an amount or concentration of methane gas in the area outside the fluid.

12. The system in claim 11, wherein the processor is arranged to:
compare the methane gas level value to a methane gas threshold value; and
power down electronics if the methane gas level value exceeds the methane gas threshold value.

13. The system in claim 1, further comprising a housing having a hermetically sealed chamber containing at least one of:
the processor;
the memory;
the communications unit;
a power supply;
a rechargeable battery;
a removable memory; and
a memory reader device.

14. The system in claim 13, wherein the housing comprises at least one of:
a sealed micro-USB port on an exterior of the enclosure; and
a sealed charge port for charging at least one of the plurality of components.

15. The system in claim 13, further comprising:
one or more magnets embedded in, or attached to, the housing for attaching the housing to a metal structure,
wherein at least one of the one or more magnets comprises a neodymium magnet for adherence to the metal structure.

16. The system in claim 2, wherein the computer program instructions comprise executable code for at least one of:
communicating, via the communication unit, with the one or more sensors to control the one or more sensors and to receive the one or more sensor signals;
communicating, via the communication unit, with one or more communicating devices;
calculating a distance by the processor to the surface of the fluid without direct contact with the fluid;
calculating a temperature value of the fluid by the processor to confirm presence of fluid inflow or infiltration;
calculating a conductivity value by the processor to detect presence of saltwater;
calculating a concentration value of a gas by the processor, including methane gas in a manhole channel;
powering down electronics, by the processor, based on the concentration value of the gas;
calculating or estimating, by the physics-based calculation or the machine learning-based calculation executed on the processor, the fluid velocity by the processor based on flow depth;
calculating or estimating, by the physics-based calculation or the machine learning-based calculation executed on the processor, the fluid flowrate based on flow depth; and
requesting, via an input-output interface, at least one input comprising a sensor height, a sample rate, an outgoing pipe diameter, an outgoing pipe slope, and an outgoing pipe roughness coefficient.

17. The system in claim 1, further comprising at least one of:
a camera arranged to capture one or more images, including a video, of a field of view;
a raindrop sensor arranged to detect precipitation, including rain or snow; and
one or more servo motors arranged to:
open and close a camera lens cover; and/or
move or pan the camera along an x-axis, a y-axis, or a z-axis, or any combination of x-, y-, z-axes so as to change the field of view, including zooming in or out.

18. The system in claim 17, wherein the field of view comprises the manhole channel and the camera is configured to record a video in the manhole channel.

19. The system in claim 18, wherein the camera is arranged to record the video in response to a signal received from at least one of:
the raindrop sensor;
the temperature sensor;
the conductivity sensor; or
the ultrasonic depth sensor.

20. A computer-implemented method for measuring or for estimating flow or flowrate of a fluid, including wastewater inflow or infiltration, using non-contact depth-based flow measurement, the method comprising:
receiving, by a computing device, a depth sensor signal from an ultrasonic depth sensor, the ultrasonic depth sensor being positionable over a manhole channel above an outgoing pipe's crown, the ultrasonic depth sensor being configured to measure a distance to a fluid's surface without direct contact with the fluid;
receiving, by the computing device, a temperature signal from a temperature sensor positionable within the manhole channel, the temperature sensor being configured to measure temperature within the manhole channel or the fluid to confirm the presence of inflow or infiltration;
receiving, by the computing device, one or more data input signals;
calculating, by the computing device, a distance to a surface of the fluid based on the received depth sensor signal; and
determining, by the computing device, a depth of the fluid in the manhole channel based on the calculated distance.
